(19) United States
(12) Patent Application Publication
(10) Pub. No.: US 2007/0094021 A1
(43) Pub. Date: Apr. 26, 2007

(54) Spelling sequence of letters on letter-by-letter basis for speaker verification

(76) Inventors: Robert W. Bossemeyer JR., St. Charles, IL (US); William J. Williams, Ann Arbor, MI (US)

Correspondence Address: LAW OFFICES OF MICHAEL DRYJA, 704 228TH AVENUE NE, PMB 694, SAMMAMISH, WA, 98074, US

(21) Appl. No.: 11/260,037

(22) Filed: Oct. 25, 2005

(51) Int. Cl. G10L 15/00

(52) U.S. Cl. 704/249

(57) ABSTRACT

A user is instructed to spell a word, or say a sequence of letters, on a letter-by-letter basis for purposes such as speaker verification. A first user may be instructed to spell a word on a letter-by-letter basis. Spoken information from the first user is recorded, in which the first user has spoken the word on the letter-by-letter basis. The spoken information from the first user is used to determine whether the first user is a second user, by for instance, identifying glottal events within the spoken information, determining characteristics of these glottal events, and comparing the glottal events with the glottal events of the second user.

### FIELD OF THE INVENTION

The present invention relates generally to using recorded spoken information from a first user to determine whether the first user is a second user, and more particularly to instructing the first user to say a sequence of letters on a letter-by-letter basis as the spoken information to be recorded from the first user.

### BACKGROUND OF THE INVENTION

For a variety of security and user-authentication applications, speaker verification has become a widely used tool. Speaker verification involves a user, the speaker, uttering some predetermined speech at a place and time when the user is known to be who he or she claims to be. This speech is analyzed and stored as the reference speech of the speaker. At a later point in time, when a party wishes to verify that the user is who he or she claims to be, the user again utters the predetermined speech. This second utterance of the speech is analyzed and compared against the reference speech recorded and stored earlier. If there is a match between the two utterances, then the speaker has been successfully verified.

One approach to speaker verification focuses on the glottal events within human speech. A glottal event may generally be defined as an acoustic wave element within speech that results from the glottis, a physical part of the body within the larynx portion of the throat, modulating the flow of air when producing speech. During voiced speech, the vocal folds of the glottis open and close rapidly and repeatedly, producing pulses of air that resonate within the vocal tract of the speaker. Each response of the vocal tract to such a pulse may be referred to as a glottal event.

For glottal events to be successfully used within speaker verification, there preferably is a large or otherwise adequate number of glottal events within a speech sample by a speaker to determine whether the speaker is who he or she is claiming to be. If the speech sample has a small or otherwise inadequate number of glottal events, speaker verification may not be able to be accomplished with the desired degree of certainty. For this and other reasons, therefore, there is a need for the present invention.

### SUMMARY OF THE INVENTION

The present invention relates to instructing a user to spell a word on a letter-by-letter basis for purposes of speaker verification. A method of an embodiment of the invention instructs a first user to say a sequence of letters on a letter-by-letter basis. Spoken information from the first user is recorded, in which the first user has spoken the sequences of letters on the letter-by-letter basis. The spoken information from the first user is used to determine whether the first user is a second user.

A computerized system of an embodiment of the invention includes a recording component and a mechanism. The recording component is to record spoken information from a first user. The mechanism is to instruct the first user to say a number of letters on a letter-by-letter basis within the spoken information, and to use the spoken information to determine whether the first user is a second user.

An article manufacture of an embodiment of the invention includes a tangible computer-readable medium, and means in the medium. The tangible computer-readable medium may be a recordable data storage medium, such as a fixed or a removable storage medium like a hard disk drive, a memory, an optical disc, and so on, or another type of tangible computer-readable medium. The means is for instructing a first user to spell a word on a letter-by-letter basis, for recording spoken information from the first user in which the first user has spoken the word on the letter-by-letter basis, and for using the spoken information to determine whether the first user is a second user.

Embodiments of the invention provide for advantages over the prior art. In particular, having a user say a sequence of letters on a letter-by-letter basis, such as by having a user spell a word on a letter-by-letter basis, is advantageous. First, it ensures that the speaker verification process has a large or otherwise adequate number of glottal events to determine whether the speaker is who he or she is claiming to be. Second, the spoken alphabet can be used to represent any word in the English language. Such words may include personal information about the subject that can be expected as input, such as the user's first and/or last name, his or her residential address information, and so on, and may further include specific sequences of letters in response to prompts to spell specific words.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless explicitly indicated, and implications to the contrary are otherwise not to be made.

FIG. 1 is a flowchart of a method for determining whether a first user is a second user, according to an embodiment of the invention.

FIG. 2 is a diagram depicting groupings of letters that have similar sounds, according to an embodiment of the invention.

FIG. 3 is a diagram of a system for determining whether a first user is a second user, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

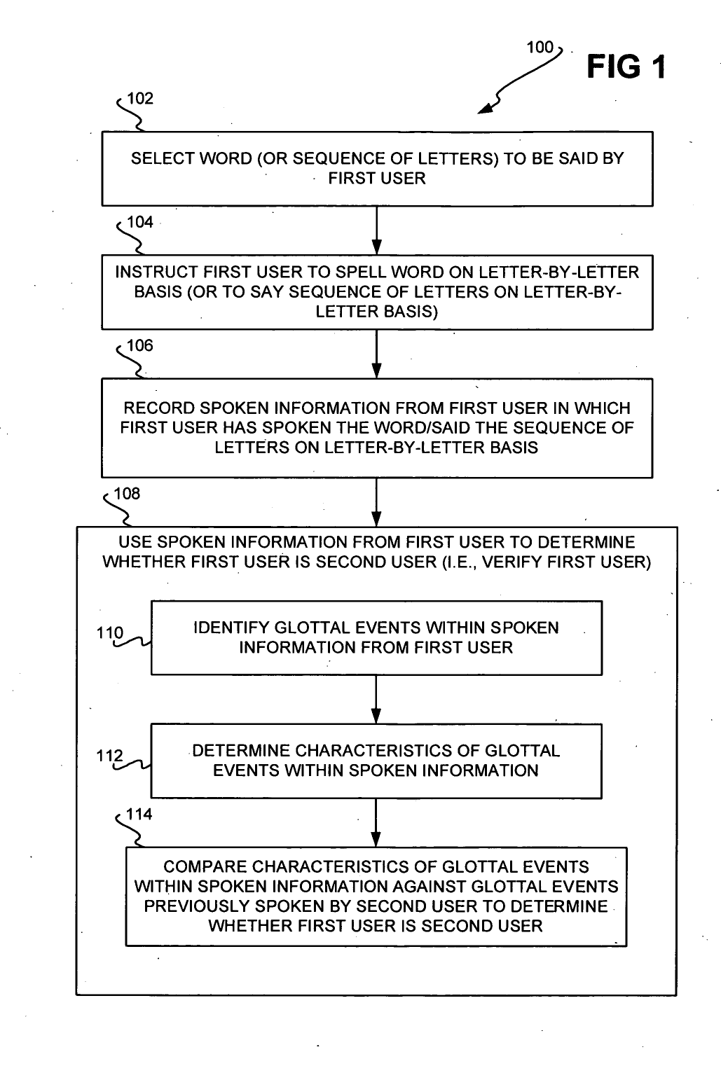

FIG. 1 shows a method 100, according to an embodiment of the invention. The method 100 is specifically for verifying a speaker, in this case determining whether a first user is a second user who the first user is claiming to be. That is, a second user may have previously uttered predetermined speech at a place and time when the second user is known to be who he or she claims to be. Thereafter, a first user comes along and may claim to be the second user. The first user may actually be the second user, or the first user may be an imposter—i.e., a user other than the second user. Therefore, speaker verification involves determining whether the first user is indeed who he or she claims to be (i.e., the second user) by using spoken information from the first user.

First, then, a word or sequence of letters to be said or uttered by the first user on a letter-by-letter basis is selected (102). The word may be one of the first name and/or last name of the second user, the second's user residential address information, or another type of word. Alternatively, a sequence of letters may be selected that is nonsensical in that it does not correspond to any English word.

In one embodiment, the word or sequence of letters is selected such that it contains at least a predetermined number of different glottal events. That is, the word or sequence of letters is selected so that it contains a sufficient number of glottal events on which basis speaker verification can be successfully performed. The word or sequence of letters may further be selected such that it maximizes the number of different glottal events. As has been described, a glottal event may generally be defined as an acoustic wave element within speech that results from the glottis, a physical part of the body within the larynx portion of the throat, modulating the flow of air when producing speech. During voiced speech, the vocal folds of the glottis open and close rapidly and repeatedly, producing pulses of air that resonate within the vocal tract of the speaker. Each response of the vocal tract to such a pulse may be referred to as a glottal event.

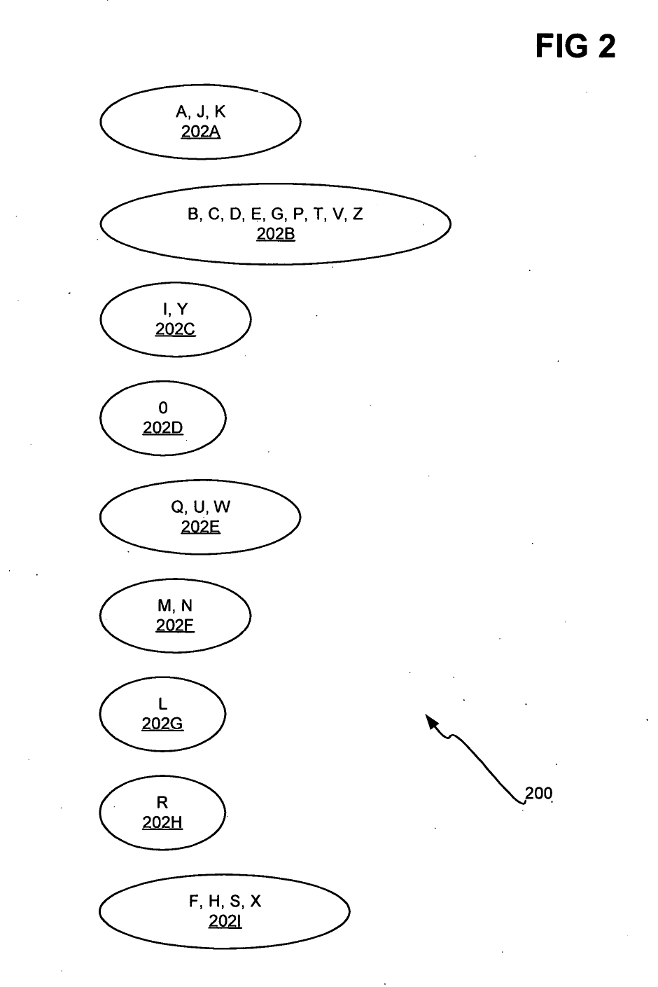

In one embodiment, the word or sequence of letters is selected such that it has at least one letter within each of a number of predetermined groups of letters. FIG. 2 shows a diagram 200 of a number of such groups of letters 202A, 202B, 202C, 202D, 202E, 202F, 202G, 202H, and 202I, collectively referred to as the groups of letters 202, according to an embodiment of the invention. The groups of letters 202 are defined such that the individual letters of the English alphabet are grouped by the similar sounds that are required to articulate them. In each of the groups of letters 202, vocalization of each of the letters within the group in question is characterized by a short initial burst of sound followed by a sustained voiced sound, where the sustained voiced sound is similar for all of the letters within the group. For example, in the group of letters 202A, the letters A, J, and K are spoken phonetically as “AAAYYY,” “JAAAYYY,” and “KAAAYYY,” where the same sound “AAAYYY” is common to all these letters.

Therefore, in one embodiment, the word or sequence of letters is selected such that it has at least one letter within a number of the groups of letters 202. For example, there are nine groups of letters 202, and it may be determined that the word or sequence of letters should be selected such that it has at least one letter within at least five of these nine groups of letters 202. It is noted that the last group of letters 202I includes mostly non-voiced sounds, and includes the letters F, H, S, and X that are not particularly useful for identifying glottal events within speech.

Referring back to FIG. 1, the first user is instructed to spell the selected word, or say the selected sequence of letters, on a letter-by-letter basis (104). For example, the user may hear voice prompts instructing the user, “please spell the word SMITH on a letter-by-letter basis,” or the user may view a display device on which this instruction has been displayed. In response, the first user utters spoken information that is recorded, and in which the first user has spoken the word or the sequence of letters on a letter-by-letter basis (106). For example, the user may utter the spoken information “ESSS, “EMMM,” “III,” “TEEE,” and “AYTCH,” which represents the spelling of the word SMITH on a letter-by-letter basis. That is, the user says each letter of the word or sequence of letters in order, such as S, followed by M, followed by I, followed by T, and followed by H.

This spoken information from the first user as recorded is then used to determine whether the first user is the second user (108), who the first user may be claiming to be, such as for speaker verification purposes. Embodiments of the invention are not limited by the approach or algorithm that is employed to use the spoken information from the first user to determine whether the first user is the second user. For instance, in one embodiment, the approach described in the previously filed and coassigned patent application, entitled “Locating and confirming glottal events within human speech signals,” filed on Oct. 31, 2003, and assigned Ser. No. 10/698,629 [attorney docket no. 1048.002US1], which is hereby incorporated by reference, may be employed.

In general, however, the following approach may be used in at least some embodiments of the invention to determine whether the first user is the second user. First, the glottal events within the spoken information are identified (110). For instance, the individual letters uttered by the first user may be located (i.e., segmented), and one or more glottal events within at least one of the letters may then be identified. Second, characteristics of these glottal events may be determined (112). For instance, signal processing or another technique may be employed to yield characteristics of these glottal events. Finally, the glottal events within the spoken information from the first user are compared against glottal events previously spoken by the second user to determine whether the first user is the second user (114). For instance, the characteristics of the glottal events uttered by the first user may be compared against characteristics of glottal events uttered by the second user previously, to determine whether the first user is indeed the second user.

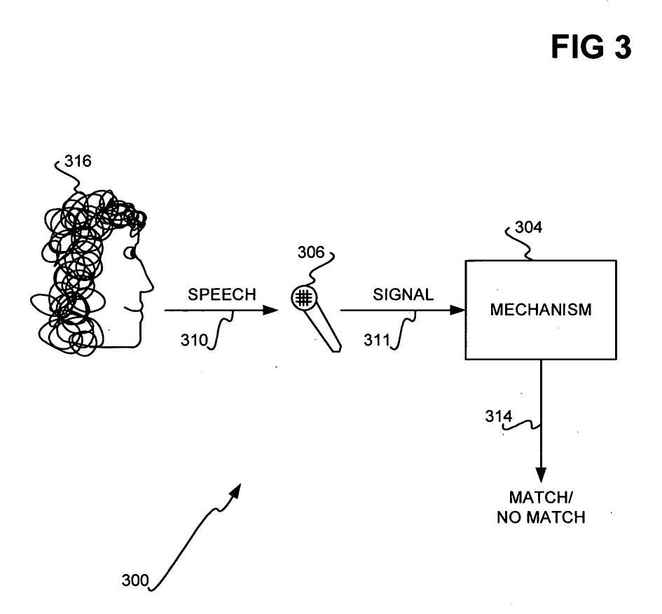

FIG. 3 shows a system 300, according to an embodiment of the invention. The system 300 can be used to implement the method 100 of FIG. 1 that has been described. The system 300 is depicted as including a mechanism 304 and a recording component 306. As can be appreciated by those of ordinary skill within the art, the system 300 may further include other components and mechanisms, in addition to and/or in lieu of those depicted in FIG. 3.

The mechanism 304 may be a computer program stored on a computer-readable medium and running on a computer. Alternatively, the mechanism 304 may be special-purpose hardware and/or software. That is, the mechanism 304 may be or include software, hardware, or a combination of software and hardware, as can be appreciated by those of ordinary skill within the art. The recording component 306 may be a microphone, or another type of device that is capable of receiving or detecting spoken information 310 and generating a signal 311 in response thereto that represents the spoken information 310.

Therefore, the mechanism 304 instructs a user 316 to say a sequence of letters, or spell a word, on a letter-by-letter basis, as has been described. In response, the user 316 utters the spoken information 310, which is recorded by the recording component 306 as the signal 311. The mechanism 304 utilizes the spoken information 310, as represented by the signal 311, to determine whether the user 316 is who he or she is claiming to be. For instance, the mechanism 304 may digitize the signal 311 by sampling the signal 311, and thereafter extract glottal events from the signal 311. Characteristics of these glottal events may be determined by the mechanism 304, and compared against previously determined characteristics of glottal events from a second user.

Where the glottal events of the user 316 adequately match the glottal events of the second user, the mechanism 304 indicates a match, as denoted by the arrow 314, such that it can be concluded that the user 316 is the second user. However, where the glottal events of the user 316 do not adequately match the glottal events of the second user, the mechanism 304 indicates a no match, as also denoted by the arrow 314, such that it can be concluded that the user 316 is not the second user. Therefore, the system 300 can be employed for the purposes of speaker verification.

It is noted that, although specific embodiments have been illustrated and described herein, it will be appreciated by those of ordinary skill in the art that any arrangement that is calculated to achieve the same purpose may be substituted for the specific embodiments shown. Other applications and uses of embodiments of the invention, besides those described herein, are amenable to at least some embodiments. For instance, whereas embodiments of the invention have been substantially described in relation to speaker verification, other embodiments of the invention can be employed for purposes other than speaker verification.

As another example, whereas embodiments of the invention have been described in relation to the utilization of glottal events within spoken information recorded from a user to determine whether the user is a particular user, other embodiments can employ the spoken information recorded from the user without utilizing glottal events. This application is intended to cover any adaptations or variations of the present invention. Therefore, it is manifestly intended that this invention be limited only by the claims and equivalents thereof.

We claim:

1. A method comprising:
instructing a first user to say a sequences of letters on a letter-by-letter basis;
recording spoken information from the first user in which the first user has spoken the sequences of letters on the letter-by-letter basis; and,
using the spoken information from the first user to determine whether the first user is a second user.

2. The method of claim 1, wherein the first user is claiming to be the second user, where the second user is a particular predetermined user.

3. The method of claim 1, further comprising selecting the sequence of letters to be spoken by the first user on the letter-by-letter basis.

4. The method of claim 3, wherein selecting the sequence of letters to be spoken by the first user on the letter-by-letter basis comprises selecting the sequence of letters as containing at least a predetermined number of different glottal events.

5. The method of claim 3, wherein selecting the sequence of letters to be spoken by the first user on the letter-by-letter basis comprises selecting the sequence of letters as maximizing a number of different glottal events.

6. The method of claim 3, wherein selecting the sequence of letters to be spoken by the first user on the letter-by-letter basis comprises selecting the sequence of letters as having at least one letter within each of a predetermined number of a plurality of groups of letters.

7. The method of claim 6, wherein the plurality of groups of letters essentially consists of:
a first group consisting of letters A, J, and K;
a second group consisting of letters B, C, D, E, G, P, T, V, and Z;
a third group consisting of letters I and Y;
a fourth group consisting of letter O;
a fifth group consisting of letters Q, U, and W;
a sixth group consisting of letters M and N;
a seventh group consisting of letter L; and,
an eighth group consisting of letter R.

8. The method of claim 7, wherein the plurality of groups of letters further essentially consists of a ninth group consisting of letters F, H, S, and X.

9. The method of claim 1, wherein using the spoken information from the first user to determine whether the first user is the second user comprises:
identifying glottal events within the spoken information from the first user;
determining characteristics of the glottal events within the spoken information from the first user; and,
comparing the characteristics of the glottal events within the spoken information from the first user against glottal events previously spoken by the second user to determine whether the first user is the second user.

10. The method of claim 9, wherein using the spoken information from the first user to determine whether the first user is the second user further comprises initially segmenting each of a plurality of letters of the sequence of letters within the spoken information from the first user, such that the glottal events are identified by identifying the glottal events within each of the plurality of the letters of the sequence of letters within the spoken information from the first user.

11. A computerized system comprising:
a recording component to record spoken information from a first user; and,
a mechanism to instruct the first user to say a plurality of letters on a letter-by-letter basis within the spoken information, and to use the spoken information to determine whether the first user is a second user.

12. The computerized system of claim 11, wherein the first user is claiming to be the second user, where the second user is a particular predetermined user.

13. The computerized system of claim 11, wherein the mechanism is further to select the letters to be said by the first user on the letter-by-letter basis.

14. The computerized system of claim 13, wherein the mechanism is to select the letters to be said by the first user on the letter-by-letter basis by selecting the letters as containing at least a predetermined number of different glottal events.

15. The computerized system of claim 13, wherein the mechanism is to select the letters to be said by the first user on the letter-by-letter basis by selecting the letters as having at least one letter within each of a predetermined number of a plurality of groups of letters.

16. The computerized system of claim 15, wherein the plurality of groups of letters essentially consists of:
a first group consisting of letters A, J, and K;
a second group consisting of letters B, C, D, E, G, P, T, V, and Z;
a third group consisting of letters I and Y;
a fourth group consisting of letter O;
a fifth group consisting of letters Q, U, and W;
a sixth group consisting of letters M and N;
a seventh group consisting of letter L; and,
an eighth group consisting of letter R.

17. An article of manufacture comprising:
a tangible computer-readable medium; and,
means in the medium for instructing a first user to spell a word on a letter-by-letter basis, for recording spoken information from the first user in which the first user has spoken the word on the letter-by-letter basis, and for using the spoken information from the first user to determine whether the first user is a second user.

18. The article of manufacture of claim 17, wherein the means is further for selecting the word to be spelled by the first user on the letter-by-letter basis.

19. The article of manufacture of claim 18, wherein the means is for selecting the word to be spelled by the first user on the letter-by-letter basis by selecting the word as containing at least a predetermined number of different glottal events.

20. The article of manufacture of claim 18, wherein the means is for selecting the word to be spelled by the first user on the letter-by-letter basis by selecting the word as having at least one letter within each of a predetermined number of a plurality of groups of letters.
